(19) United States
(12) Patent Application Publication
(10) Pub. No.: US 2009/0129617 A1
(43) Pub. Date: May 21, 2009

(54) Hearing aid device, in particular IE hearing device

(75) Inventors: Markus Heerlein, Singapore (SG); Harald Klemenz, Singapore (SG); Daniel Reisse, Erlangen (DE); Markus Wild, Unterdietfurt (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/313,163

(22) Filed: Nov. 18, 2008

(30) Foreign Application Priority Data
Nov. 20, 2007 (DE) 10 2007 055 384.8

(51) Int. Cl. H04R 25/00

(52) U.S. Cl. 381/323; 381/328

(57) ABSTRACT

Disclosed is a hearing aid device, in particular an IE hearing device with a battery receiving space and a battery charger, with it being possible to move a battery for the hearing aid device into the battery receiving space by means of the battery charger, and for an immersion depth of the battery into the battery receiving space to be varied as a function of an embodiment of the battery charger. The invention also relates to a hearing aid device set with a hearing aid device and a plurality of differently embodied battery chargers, as well as a method for the production of the hearing aid device.

### CROSS REFERENCE TO RELATED APPLICATIONS

This application is claims the benefits of German application No. 10 2007 055 384.8 filed Nov. 20, 2007 and is incorporated by reference herein in its entirety.

### FIELD OF INVENTION

The invention relates to a hearing aid device, in particular an in-ear hearing device, having a battery receiving space and a battery charger. The invention also relates to a hearing aid device set with a hearing aid device as well as a method for manufacturing the hearing aid device.

### BACKGROUND OF THE INVENTION

Hearing aid devices and hearing devices generally comprise a housing and/or a housing shell, in which a microphone, an amplifying device, a receiver and/or loudspeaker, a power supply, mostly a zinc-air battery inter alia are arranged. The receiver is connected to an acoustic output of the housing and/or housing shell, which emits the acoustic signals generated and prepared by the hearing aid device and/or hearing device into an auditory canal of a wearer of the hearing aid device and/or hearing device.

An adjustment of hearing devices to different hearing damages by means of different performances and to differing customer requirements, as well as the demand by customers for small and smallest installation sizes, obliges the hearing device manufacturer to create a wide range of hearing devices with a different functional range for different power levels. This results in a plurality of differently sized hearing devices, which are on the one hand to be individually adjusted to hearing damages and customer requirements and on the other hand to the conditions of a relevant human ear.

In order to meet the aesthetic requirements of a wearer of the hearing device, this is to be as minimally externally visible on the wearer as possible. A therefore necessary miniaturization of the hearing devices on the one hand and the preferably versatile functional scope thereof as well as a high-quality processing of the signals needed to improve a hearing ability within the hearing device on the other hand represent opposite requirements. These requirements are particularly high especially in the case of hearing devices worn in the ear, referred to below with in-ear hearing device and/or IE hearing device. The components needed for an IE hearing device are thus to be designed as small as possible within the IE hearing device, to be packed as tightly as possible and to be reduced to a minimum.

It is difficult, particularly in the case of IE hearing aid devices, to secure a comparatively large accumulator and/or a comparatively large battery, like for instance a battery in a 312 battery size, in an interior of the IE hearing aid device, without a battery charger for the battery resting internally against a housing shell of the IE hearing device and/or coming into contact with other components within the IE hearing device. This problem increases further in the case of anatomically difficult ears having for instance a very narrow or angled auditory canal.

It is however desirable to accommodate a battery with the largest possible capacity and thus the largest possible battery in the case of IE hearing aid devices, so that the IE hearing aid device has a long service life with one single battery.

This problem was previously only solved to that effect that in the case of an IE hearing aid device the housing shell was not milled downward to such a degree on an outer distal side which faces away from the eardrum, as would actually be possible and also desirable. In this way, large housing shells which protrude far out of the ear are achieved, which do not meet the aesthetic requirements of the wearer of the hearing aid device.

WO 00/79834 A1 discloses a behind-the-ear hearing device and/or BTE hearing device and a plug-in module for the same. In this way the BTE hearing device can be extended in its functional scope by the plug-in module. To this end, a plug-in part of the plug-in module is inserted into a battery compartment of the hearing device and is as a result electrically and mechanically connected to the BTE hearing device. With this BTE hearing device which is extended by the plug-in module, the battery is then located in the plug-in module. The plug-in module provides an interface for a wireless signal transmission, a programming unit, a further audio input, a larger battery compartment and/or a mechanical actuation unit for instance.

EP 1 563 712 B1 discloses a set and a method for the manufacture of an IE hearing aid device, as well as an IE hearing aid device. An IE hearing aid device which can be individually adjusted to an auditory canal can be manufactured by means of a casting space element with a membrane and one or a plurality of casting cores, with one of the cores creating space for an electronic module within an existing otoplastic. After removing the core, the electronic module can be inserted into the otoplastic. The electronic modules of a series which are provided with a battery charger are all designed to be identical here.

### SUMMARY OF INVENTION

It is an object of the invention to provide an improved hearing aid device, in particular an improved IE hearing device. One object of the invention is to provide an improved hearing aid device set with a hearing aid device, in particular an IE hearing device and a battery charger, as well as an improved method for producing the hearing aid device, in particular the IE hearing device.

In accordance with the invention, a hearing aid device, a hearing aid device set and a method for manufacturing the hearing aid device is to be made available, with it being possible in the case of hearing aid devices with different housing configurations to accommodate a battery with a specific size. The hearing aid device, in particular a housing shell of the hearing aid device, is also to have the smallest possible volume here, i.e. is to be embodied as small as possible. Different curvatures of the housing shell can be taken into consideration here.

The invention is achieved by means of a hearing aid device, in particular an IE hearing device, according to the claims, by means of a hearing aid device set with a hearing aid device, in particular an IE hearing device, according to the claims and by a method for manufacturing the hearing aid device, in particular the IE hearing device, as claimed in the claims.

In accordance with the invention, a plurality of different battery chargers is made available for a hearing aid device, with the hearing aid device and the plurality of battery chargers together forming the hearing aid device set. The inventive battery chargers vary in terms of size, appearance and/or volume, and/or the position of a battery which can be provided in the relevant battery charger in respect of a supporting point of the battery charger in/on the hearing aid device, as a result of which a position of the battery relative to the hearing aid device can be changed and can be freely selected to some degree, depending on the battery chargers available, provided the battery can be moved into a correct electrical contact with the hearing aid device.

It is as a result possible in accordance with the invention to select a position of the battery in the hearing aid device accordingly and to attune the battery and the hearing aid device to one another in accordance with customer requirements. In particular, it is possible in accordance with the invention, despite difficult anatomical conditions, to accommodate the smallest possible IE hearing device in a base of the concha of a human ear.

The inventive battery cover and/or the inventive set made of battery covers also exists in different sizes and/or heights, as a result of which the battery can be moved at different depths into a battery receiving space of the hearing aid device when closing the battery charger. In the case of battery chargers, it is thus possible for instance, to provide a center point of a battery which can be provided in/on a battery compartment of the battery charger at different distances in respect of a fastening point of the battery chargers on the hearing aid device.

In accordance with the invention, it is possible to provide the center point of the battery which can be provided in the battery compartment in respect of the fastening point of the battery charger in/on the hearing aid device such that different immersion depths into the hearing aid device of the battery charger and/or the battery which can be provided in the battery compartment result. In this way, the battery can completely immerse or only immerse in sections into the hearing aid device. It is even possible in accordance with the invention, by providing a corresponding electrical contacting for the battery, to prevent these from immersing into the housing shell of the hearing aid device. With such an embodiment, a front cover and/or the battery charger is then configured accordingly.

When manufacturing the inventive hearing aid device, a plurality of differently configured battery chargers can be provided firstly on the hearing aid device, with the hearing aid device and/or a housing shell or a front cover of the hearing aid device being changed in a following manufacturing step such that all battery chargers can no longer be provided in/on the hearing aid device. In accordance with the invention, the hearing aid device and/or housing shell and/or the front cover is changed in accordance with customer requirements and a suitable battery charger is sought, with it being possible on the one hand for the size of the battery to be influenced and on the other hand the size of the whole hearing aid device to be influenced.

With the inventive method for manufacturing the hearing aid device, the housing shell is processed for a specific ear in accordance with customer wishes such that one or a plurality of battery chargers can be provided in/on the hearing aid device. In embodiments of the invention, the housing shell can be milled downward to such a degree that a single battery charger of the battery chargers available can be selected. An individual smallest hearing aid device can be realized as a result.

It is also possible in accordance with the invention to mill a housing shell downward to such a degree that a battery charger with the smallest possible immersion depth into the battery receiving space of the hearing aid device can be selected. The housing shell can also be milled downward to such a degree that the battery and/or the battery charger rests internally against the hearing aid device when the battery charger is closed in/on the hearing aid device or is at a distance therefrom with the smallest possible gap.

The hearing aid device is embodied in accordance with the invention such that on the basis of a different embodiment of the battery charger and/or battery chargers, the immersion depth of the battery which can be provided in the battery charger into the hearing aid device can be modified and/or changed in the hearing aid device. To this end, the hearing aid device preferably has a battery receiving space, which is preferably embodied to be so large that just the battery, if necessary sections of the battery charger, can be received therein. The battery receiving space is preferably limited by the front cover of the hearing aid device, with the front cover being provided on the housing shell of the hearing aid device.

In accordance with the invention, it is preferred that the battery charger be mounted in a moveable fashion at least on the front cover. The mounting allows the battery charger to be moveable to and fro into the battery receiving space in a translatory fashion and/or on a curved path. In preferred embodiments of the invention, the battery charger is provided so as to be moveable on a circular path on the hearing aid device, in particular on the front cover.

When closing the battery charger from an open position, the battery charger moves the battery provided therein preferably at least partially into the battery receiving space, in which the battery can then be contacted by corresponding electrical contacts for powering the hearing aid device, with the battery charger then being in its closed position in/on the hearing aid device.

In preferred embodiments of the invention, a mounting of the battery charger on the hearing aid device is realized by way of a snap-on, clip-on, click-on, or plug-in connection, which on the one hand realizes a corresponding stop of the battery charger in the closed position thereof and also ensures a corresponding guide when opening and/or closing the battery charger.

In this way, the mounting, e.g. made of a pin and/or an axis on the battery charger and a corresponding partially open shell in terms of its periphery can be realized on the front cover and/or housing shell, with the pins of the battery charger being easily “clicked in” into the mounting shell. Such an embodiment of the mounting ensures a simple and rapid exchange of battery chargers. A kinematic inversion is naturally possible here.

In preferred embodiments of the invention, the battery charger is provided in/on the hearing aid device in an exchangeable fashion. It is preferred here that the battery charger can be exchanged as easily as possible by hand without an additional tool being needed herefor. The battery charger is connected to the hearing aid device for instance by means of a detachable, preferably an easily detachable mechanical connection, with it also be preferred that this mechanical connection assumes a mounting of the battery charger in/on the hearing aid device in all positions from the open to the closed position and back again.

According to the invention, the hearing aid device is configured with its paired battery charger such that when the battery charger is closed in/on the hearing aid device, the hearing aid device can electrically contact the battery provided in the battery charger. In this way, the battery can protrude more or less into the battery receiving space of the hearing aid device when the battery charger is in the closed position.

According to the immersion depth of the battery and/or battery charger in the battery receiving space of the hearing aid device, an exterior surface of the battery charger is adjusted. It is preferred here that the battery charger assumes as little additional space as possible. A flat embodiment on the exterior surface of the battery charger, which fits harmonically into the overall image of the hearing aid device and/or human ear, is preferred here.

According to the invention, a plurality of different battery chargers can also be provided for one and the same hearing aid device. In this way, a wearer of the hearing aid device can choose between an aesthetic aspect of the hearing aid device with a comparatively short service life and a comparatively long service life but a large hearing aid device, depending on a situation.

If the wearer sets value on the smallest possible hearing aid device, he/she selects a battery charger for a smaller battery, with the battery charger protruding as little as possible from the front cover. If the wearer sets value on a long service life of the hearing aid device, he selects the largest possible battery charger which accordingly protrudes far out of the front cover and accordingly enlarges the hearing aid device. A position of the battery which can be provided in the respective battery compartment of the relevant battery charger is then adjusted accordingly to the electrical contacting in/on the hearing aid device.

In particular, in the case of a battery charger which is provided so as to be pivotable on the hearing aid device, it may be advantageous for a complete or preferably wide opening of the battery charger to provide a recess in the battery charger and/or the hearing aid device between the battery charger and the hearing aid device at a corresponding external collision point, in order to be able to open the battery charger even wider in order as a result to render the battery more easily accessible for a manual replacement. This relates in particular to collision regions in the vicinity of a pivoting axis of the battery charger in/on the hearing aid device.

In order to use space optimally within the hearing aid device, the battery charger may not be completely closed in a peripheral region for the battery to be accommodated, i.e. the battery charger then surrounds the battery provided therein only at a peripheral angle of greater than 180° and less than 360°.

Further embodiments of the invention result from the remaining dependent claims.

### BRIEF DESCRIPTION OF THE DRAWINGS

The invention is described in more detail with the aid of exemplary embodiments with reference to the appended drawings, in which;

FIG. 1 shows a three-dimensional representation of a hearing device to be worn in the ear;

FIG. 2 shows a cutout partial side view of an inventive hearing aid device with a first embodiment of an inventive battery charger in a closed position in/on the hearing aid device;

FIG. 3 shows a view of the hearing aid device from FIG. 1 with a second embodiment of the inventive battery charger; and

FIG. 4 shows a view of the hearing aid device from FIG. 1 with a third embodiment of the inventive battery charger.

### DETAILED DESCRIPTION OF INVENTION

The invention is described in more detail below with the aid of a hearing device which is worn in the ear—subsequently referred to as IE hearing device. The invention is however not to be restricted to such IE hearing devices, but can instead be quite generally applied to hearing aid devices. Devices, which are used not only to improve a hearing weakness but are instead also suited to improving a hearing ability of a wearer of the hearing aid device in an acoustically difficult situation, like for instance on a building site, also apply. This relates for instance to an ear protection system with an integrated receiver.

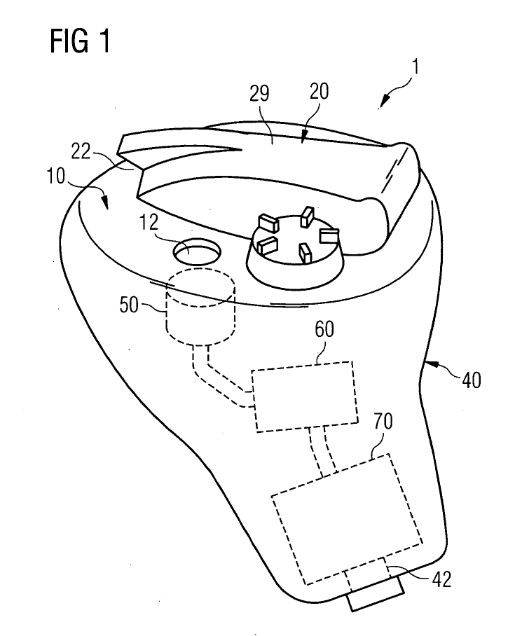

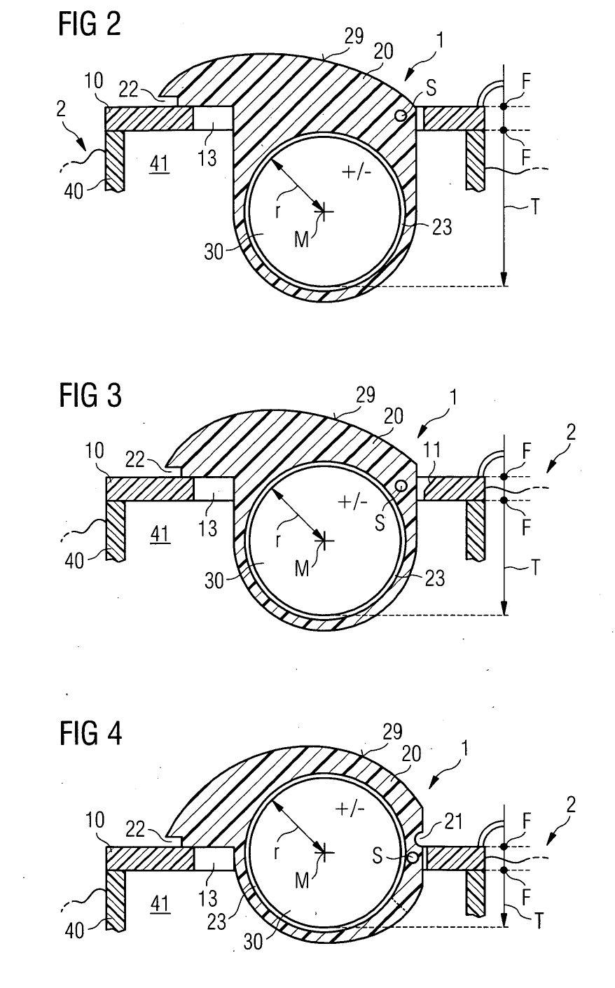

FIG. 1 shows a three-dimensional representation of a housing shell 40 of an IE hearing device 1 consisting of plastic, said IE hearing device being reproduced in the form of an auditory canal, into which it can be inserted. The housing shell 40, which receives the hearing device components, like a microphone 50, an amplifier 60, a receiver 70, etc., are closed by means of a front cover 10, which has an opening 13 (see FIGS. 2 to 4) which can be sealed by means of a battery charger 20, on an external distal side which faces away from the ear drum of the auditory canal.

A sound inlet opening 12 is provided in the front cover 10 for a sound inlet to the microphone 50. A sound outlet canal 42 at the proximal end of the IE hearing device 1 conveys the sound signals of the receiver 70 into the auditory canal and thus to the ear drum of a wearer of the IE hearing device 1.

The individually manufactured housing shell 40, also known as otoplastic 40, is produced with the aid of an imprint of an ear 2 (see FIGS. 2 to 4) of the wearer. Uniform front covers 10 are used for a front-sided seal of a respective housing shell 40, said front covers 10 being glued to a distal edge of the housing shell 40. A protruding region of the front cover 10 is then separated and a transition from the front cover 10 to the housing shell 40 is processed. In other embodiments of the invention, the front cover 10 can also be a component, in particular an integral component, of the housing shell 40.

FIGS. 2 to 4 now show an embodiment of the IE hearing device 1 in each instance, with an immersion depth T of a battery 30 in the IE hearing device 1 being embodied so as to be a different size. FIG. 2 shows a battery 30 with a large immersion depth T in the IE hearing device 1, as a result of which FIG. 4 shows an embodiment of the invention, in which a battery 30 has a minimal immersion depth T. The embodiment according to FIG. 3 has an immersion depth T, which lies between that in FIG. 2 and that in FIG. 4.

The immersion depth T is preferably measured from a fixed point F, on the IE hearing device 1, preferably a fixed point F on the front cover 10 and refers for instance, like shown in FIGS. 2 to 4, to the length from the fixed point F to that point of the battery 30, which immerses as far as possible into the IE hearing device 1 when the battery charger 20 is in the closed position. Other points can naturally also be used on the battery 30 for this purpose. The center point M thereof is also suitable for this for instance. The immersion depth T is preferably defined such that a horizontal distance in respect of the front plate 10 is meant for instance.

The front cover 10 and the housing shell 40 delimit a battery receiving space 41 of the IE hearing device 1, into which the battery charger 20 can be at least partially clipped, with the battery charger 20 in FIGS. 2 to 4 being shown in its respective closed position on the IE hearing device 1. In accordance with the invention, the immersion depth T of the battery 30 into the battery receiving space 41 can be variable as a function of an embodiment of the battery charger 20.

It is thus possible for instance, as shown in FIG. 2, to accommodate the battery 30 completely within the IE hearing device 1. In one embodiment of FIG. 3, the battery 30 is no longer located only in the battery receiving space 41, but protrudes instead into the opening 13 of the front cover 10 for the battery charger 20. In one embodiment of FIG. 4, the battery charger 20 is embodied such that the battery 30 is provided at least partially within the battery receiving space 41 and partially outside the front cover 10 on/in the IE hearing device 1. I.e. with such an embodiment, the battery 30 protrudes through the opening 13 of the front cover 10.

The battery 30 can be accommodated in a battery compartment 23 of the battery charger 20. It is possible here, as shown in FIGS. 2 to 4, for the battery charger 20 and/or the battery compartment 23 to completely surround the battery 30 in terms of its periphery and thus to hold the battery 30 in the battery compartment 23 of the battery charger 20.

In different embodiments of the invention, it is however possible to embody the battery compartment 23 so as to be open such that this partially surrounds the battery 30, which is shown in a dotted fashion in FIG. 4. With such an embodiment, a shorter circumferential section of the battery 20 is omitted. It is possible as a result to create space within the IE hearing device 1 and/or to provide corresponding components within the IE hearing device 1 lying thereabove (in respect of FIGS. 2 to 4) and/or to process the housing shell 40 further downward and as a result to embody the overall IE hearing device 1 to be smaller.

In preferred embodiments of the invention, that section of the battery charger 20, which is located in the closed position of the battery charger 20 with respect to the FIGS. 2 to 4 above the front cover 10, is adjusted accordingly. I.e., the further the battery 30 can be accommodated within the IE hearing device 1 by means of the inventive battery charger 20, the flatter the corresponding exterior surface 29 of the battery charger 20, which can be easily identified in FIGS. 2 to 4.

The battery charger 20 shown in FIGS. 2 to 4 can be pivoted into and/or out of the IE hearing device 1 in a rotational fashion in respect of a pivoting axis S. It is however possible also to allow for a linear movement and/or to provide the battery charger 20 so as to be moveable to and fro in the IE hearing device 1 exclusively in a translatory fashion. A connection of the battery charger 20 with the IE hearing device 1 preferably takes place by way of a suitable connection with the front cover 10 which provides for corresponding moveability. This can also be realized with the housing shell 40 in different embodiments of the invention.

In preferred embodiments of the invention, a mounting of the battery charger 20 on the front cover 10 is realized by way of a simple, detachable connection, in particular a pivoting connection. I.e. it is preferred that the battery charger 20 can be connected in a pivotable fashion to the front cover 10 by means of a simple movement. This is preferably produced by means of a simple click-on mechanism, with it being possible to remove the battery charger 20 from the front cover 10 and to click a new battery charger 20 thereupon.

Other mountings of the battery charger 20 which allow pivoting and/or translatory movements in/on the IE hearing device 1 and/or the front cover 10 thereof and/or the housing shell 40 thereof are naturally possible, with it being preferred that this mounting be producible as far as possible without an additional tool and detachable again.

To ensure as wide an opening of the battery charger 20 as possible, the front cover 10 can have a recess 11, e.g. in the form of a bezel, on the edge of its opening 13 for the battery charger 20 and adjacent to the pivoting axis S, said recess enabling the battery charger 20 to pivot further in respect of the front cover 10.

This is also possible, as shown in FIG. 4, with a recess 21 in the battery charger 20. The recess 21 within the battery charger 20 is similarly provided adjacent to the pivoting axis S of the battery charger 20 such that in the open position of the battery charger 20, a limit and/or an edge of the opening 13 for the battery charger 20 can be received. In embodiments of the invention, both recesses 11, 21 can also be used.

To facilitate an opening of the battery charger 20, this has a recess 22 and/or a recessed grip 22, which, opposite to the pivoting axis S, is provided in/on the battery charger 20 and forms a type of groove when the battery charger 20 is in a closed position with the front cover 10.

In accordance with the invention, the different heights of the battery charger 20 achieve space in a region of the housing shell 40 in the vicinity of a base of the concha of the human ear 2. It is as a result possible in accordance with the invention to operate in a more flexible fashion during the manufacturing process of IE hearing device 1 in the case of the immersion depth T of the battery 30. A size of the used battery charger 20 can be selected in accordance with the invention depending on the anatomy of the human ear 2.

In accordance with the invention, during the manufacturing process of the IE hearing devices 1, it is possible to process a height of the housing shell 40 so as to be lower and thus to embody the overall IE hearing device 1 smaller. Particularly with problem ears 2, in which the base of the conch protrudes relatively far, the inventive variation of different battery chargers 20 offers significant benefits in terms of the manufacturing process. In accordance with the invention, the smallest individual IE hearing devices 1 can be manufactured, which can also subsequently be adjusted to a desired service life.

A radius r and/or a radius length r of the battery 30 is referred to in FIGS. 2 to 4 with r.

1.-22. (canceled)

23. An IE hearing aid device, comprising:
a battery receiving space; and
a battery charger configured such that a battery associated with the hearing aid device is movable into the battery receiving space by the battery charger,
wherein an immersion depth of the battery is varied in the battery receiving space as a function of a physical embodiment of the battery charger.

24. The hearing aid device as claimed in claim 23, wherein
the battery charger is exchangeable in/on the hearing aid device, and
the battery charger is sized and configured such that the battery associated with the hearing aid device is changeable without necessitating use of a tool.

25. The hearing aid device as claimed in claim 24, wherein the battery charger is connected to the front cover via an easily detachable, mechanical connection.

26. The hearing aid device as claimed in claim 25, wherein the battery receiving space is delimited by a housing shell and/or a front cover, on which the battery charger is moveably mounted.

27. The hearing aid device as claimed in claim 26, wherein the battery charger is connected to the hearing aid device and/or housing shell or the front cover via a snap-on, clip-on, click-on or plug-in connection.

28. The hearing aid device as claimed in claim 27, wherein the battery charger is pivotable on the hearing aid device and/or the housing shell or the front cover.

29. The hearing aid device as claimed in claim 28, wherein the battery charger is moveable into the battery receiving space in a translatory and/or rotary fashion.

30. The hearing aid device as claimed in claim 29, wherein the battery charger is configured such that the battery the battery associated with the hearing aid device is at least partially inside the battery receiving space when the battery charger on the hearing aid device is closed.

31. The hearing aid device as claimed in claim 30, wherein the battery charger is configured such that when the battery charger on the hearing aid device is closed, a distance of a center point of the battery relative to an outer delimitation of the housing shell or the front plate amounts to approximately two times a radius of the battery or less.

32. The hearing aid device as claimed of claim 31, wherein for a battery charger that protrudes from a hearing aid device in the closed state, a recess is provided in the front cover and/or the battery charger that facilitates an opening/closing of the battery charger.

33. The hearing aid device as claimed in claim 32, wherein the recess in the front cover and/or the battery charger is arranged in a vicinity of a pivoting axis of the battery charger.

34. The hearing aid device as claimed in claim 33, wherein the battery charger is closed in a circumferential region of the battery.

35. The hearing aid device as claimed in claim 33, wherein the battery charger is open in a circumferential region of the battery.

36. An IE hearing aid device set, comprising:
a plurality of geometrically differently embodied battery chargers; and
an IE hearing aid device body configured and arranged to accommodate the plurality of differently embodied battery chargers.

37. The hearing aid device set as claimed in claim 36, wherein the battery chargers are differently embodied such that
a fastening point of a battery charger on the hearing aid device has a different distance from a center point of a battery associated with the charger, than another of the plurality of geometrically differently embodied battery chargers.

38. The hearing aid device set as claimed in claim 37, wherein the battery chargers are differently embodied such that different immersion depths of the battery into the hearing aid device are realized.

39. The hearing aid device set as claimed in claim 36, wherein the IE hearing aid device comprises a battery receiving space, wherein an immersion depth of the associated battery is varied in the battery receiving space as a function of a physical embodiment of the particular battery charger.

40. A method for manufacturing an IE hearing aid device, comprising:
providing a plurality of geometrically differently embodied battery chargers;
determining a battery to be associated with an IE hearing aid device;
processing downward a housing shell of the hearing aid device for a specific ear; and
selecting a specific battery charger of the plurality of geometrically differently embodied battery chargers from the downward processing.
